(19) United States
(12) Patent Application Publication
(10) Pub. No.: US 2007/0157566 A1
(43) Pub. Date: Jul. 12, 2007

(54) Article and method for wrapping such with a polymeric film

(76) Inventors: Yoav Guthman, D.N. Negev (IL); Maor Segal, D. N. Negev (IL); Aharon Ben-Soussane, Beer Sheva (IL); Yliftach Nir, Yokneam Illit (IL)

Correspondence Address: NATH & ASSOCIATES, 112 South West Street, Alexandria, VA, 22314, US

(21) Appl. No.: 10/588,761

(22) PCT Filed: Feb. 9, 2005
(86) PCT No.: PCT/IL05/00157

§ 371 Date: Aug. 8, 2006

(51) Int. Cl. F16B 4/00; B65B 53/02

(52) U.S. Cl. 53/442; 428/34.9

(57) ABSTRACT

The present invention provides a polymeric sheet prepared by short-gap stretching technique and being shrinked along its main axis. Such sheets may be utilized for wrap-around applications, obtaining shrinkage of polymeric sheets to particularly small dimensions along the machine direction, and wrapping articles in the wrap-around method even when these articles include locations of circumferences of considerably different dimensions.

### FIELD OF THE INVENTION

This invention relates to novel uses of polymeric films produced by stretching in the longitudinal direction, and in particular by short-gap stretching.

### BACKGROUND OF THE INVENTION

In the context of the present invention, a short-gap-stretching process is any process involving transferring a heated polymeric film from a first heated roll having a first radius and revolving in a first radial velocity to a second heated roll having a second radius and revolving in a second radial velocity, that is larger than said first radial velocity, through a gap which is as small as possible. Two publications that describe such processes are: U.S. Pat. No. 5,184,379 and U.S. Pat. No. 6,375,781.

In the article entitled “Industrial Applications Of SML Short Gap Monoaxially Film Stretching Process” (http://olypm.wu-wien.ac.at:8080/usr/h98a/h9851644/news/news8.htm), the author describes the short-gap-stretching method he uses, some of the properties of films obtained thereby, and a variety of possible uses thereof.

The present invention suggests novel uses for such films, and even more generally, for films produced by unidirectional stretching in the longitudinal direction.

### SUMMARY OF THE INVENTION

According to one of its aspects, the present invention provides a method for wrapping an article with a heat shrinkable polymeric film comprising:

(a) providing a polymeric film produced by a process including stretching said film mainly in its longitudinal direction, said stretching being by means comprising at least one pair of rollers rotating in mutually different linear velocities, the gap between said rollers being at least 10 times smaller than the width of said film to obtain a heat shrinkable polymeric film;

(b) surrounding at least a portion of the outer surface of said article with a portion of said heat shrinkable polymeric film; and

(c) heating said heat shrinkable polymeric film so as to shrink it around said article.

According to another aspect of the present invention, there is provided an article wrapped by a method according to the invention.

Typical articles to be wrapped according to the present invention are containers, particularly cylindrical containers, most particularly cylindrical containers with non-uniform diameter such as drink-containing bottles, drinking cans, containers for liquid soap, shampoo containers, batteries, medications, bottles with tamper evidence seals, etc. However, the invention is not limited to the wrapping of such articles, and may be used for wrapping articles of any shape or form, such as forks, cups, boards, etc.

The term wrapping an article should be construed, in the context of the present invention, as to surrounding the article in close proximity to the outer surface thereof. In many cases, wrapping includes the attachment of the wrapping film to the entire surface of the wrapped portion of the article. However, this is not necessarily the case, and the invention is not limited to such cases.

A heat shrinkable film is a film that shrinks upon heating. It may shrink in two dimensions (biaxially shrinkable film) or only in one dimension (monoaxially shrinkable film). The shrinkable films according to the present invention shrink along one direction, while along the other direction they retain their original dimensions, or change by no more than 5%.

The stretching of the film is mainly along its longitudinal direction, while contraction in other directions is practically impaired by the use of rollers having between them a distance which is at least ten times smaller than the width of the film (or of the rollers). The distance between the rollers may be in accordance with the present invention smaller than the width of the film in a factor of between 10 and 5000, preferably between about 50 and about 2500.

According to one embodiment of the invention, the shrinkable film is used when its shrinkable dimension is in the direction of the film flow, and the wrapping is carried out in the wrap around method.

According to another embodiment, the film wrapped around the article in the sleeve method, namely, it is first cut, closed to form a sleeve having its main axis in the direction of the film flow, the article is inserted into the sleeve, which is then heated to shrink around the article.

The degree of shrinking obtained in the method according to the invention may be between about 10% and about 90%. While 20% shrinkage may also be obtained with other production technologies, for applications where shrinkage of 60% or more is required, the present invention, which uses polymeric film produced by the short-gap-stretching process, is the only technical solution known to the inventors to date. Accordingly, the present invention also provides a polymeric sheet that is unidirectionally shrinked along its main axis (namely in the machine direction) to 50% or less of its original dimension, preferably to 40% or less. In case the polymeric sheet is made of polyolefin, such as polyethylene or polypropylene, the state of the art allows unidirectional shrinking to no less than 75% of the original dimension in the machine direction, and the present invention provides sheets made by such polymers that are shrinked to 70% or less, preferably to 60% or less of their original dimension. The possibility to shrink polymeric sheets to a large degree allows wrapping an article in the wrap-around method, even if its circumference in one location is considerably different from the circumference in another location. In this connection, considerably different means difference of 50% or more, and in the wrapping polymer is polyolefin, difference of 30% or more.

A polymeric film, for use in accordance with the invention may be composed of any polymeric material known in the art per se, and some examples for these are: polystyrene, polyolefins, such as polyethylene, polypropylene, polyvinylchloride, polyamides, Polyester, nylon, copolymers thereof, mixtures thereof, cyclic olefinic copolymers, etc. In particular, a shrinkable polymeric film that is a multilayer is also suitable for use in accordance with the invention. Non-limiting examples for suitable heat shrinkable polymers are such multilayers wherein all the multilayer is stretched as in (a) above, and a multilayer that is produced by attaching a layer that is stretched as in (a) above to another layer, for example, to a bidirectionally oriented layer. Such attaching may be carried out in any of the methods known in the art, such as lamination, coextrusion, and the like.

In accordance with the polymer and additives used, the wrapping may have characteristics such as being a barrier to gases such as oxygen, nitrogen, air, and CO₂, and/or to water vapor, UV rays, or combinations thereof. In this way, wrappings that lengthen the shelf life of articles that are sensitive to water, oxygen, and/or LW may be obtained.

The temperature to which a film must be heated to shrink it is as known in the art regarding similar films that were obtained by other techniques (i.e. between about 80 and about 120° C., depending on the kind of polymer applied), although some adjustments may be required.

### DETAILED DESCRIPTION OF A POSSIBLE EMBODIMENT

In order to understand the invention and to see how it may be carried out in practice, a possible embodiment will now be described, by way of non-limiting example only.

A polymeric film was produced from a blend of two polyethylene resins, one of which was produced in Spain by Dow Plastics and sold under the trade-name of Dowlex™, and the other produced by Basell Polyolefins (Germany) and sold under the trade-name of Hostalen™. The polymer was processed in a short-gap-stretching machine produced by Lenzing Aktiengesellschaft, described in U.S. Pat. No. 5,184,379, at a heating temperature of 100° C.-120° C. and a stretch ratio of 1:6 to produce a monoaxially heat shrinkable film. The film produced in this way underwent shrinkage by up to 70% upon subsequent heating to 100° C.-110° C.

The obtained monoaxially shrinkable film was used for wrapping a plastic bottle in the shape of a woman, having a maximal outer diameter of 6.84 cm and minimal outer diameter of 6.05 cm. The wrapping was carried out on a KRONES roll-fed shrink labeling systems type Krones Contiroll 720-12, at 18,000 bottles per hour and at a tunnel temperature of 250° C.

The film was wrapped around a drum, cut to form a label, and glue was applied to the label's edges. Then the label was wrapped around the bottle such that the glued edges attached the label to the bottle, and the labeled bottle was heated to let the label shrink. This is in contrast to the sleeve method, which is not in accordance with the present invention, wherein the article to be wrapped is introduced into a sleeve made of the wrapping polymer, and then the sleeve is shrunk.

1-30. (canceled)

31. A method for wrapping an article with a heat shrinkable polymeric film comprising:
(a) providing a polymeric film produced by a process including stretching said film mainly in its longitudinal direction, said stretching being by means comprising at least one pair of rollers rotating in mutually different linear velocities, the gap between said rollers being at least 10 times smaller than the width of said film to obtain a heat shrinkable polymeric film;
(b) surrounding at least a portion of the outer surface of said article with a portion of said heat shrinkable polymeric film; and
(c) heating said heat shrinkable polymeric film so as to shrink it around said article.

32. A method according to claim 31, wherein said gap is smaller than the width of said film by a factor of between 10 and 5000, preferably between 50 and 2500.

33. A method according to claim 31, wherein step (b) is carried out in the wrap around method or the sleeve method.

34. A method according to claim 31, wherein said article is a container.

35. A method according to claim 34, wherein said container is cylindrical and has a non-uniform diameter.

36. A method according to claim 35, wherein the shrinkable film is used with its shrinkable dimension in the direction of the film flow.

37. A method according to claim 31, wherein said film shrinks to between about 90% and about 10% of its original dimension.

38. A method according to claim 37, wherein said film shrinks to about 40% or less of its original dimensions.

39. A method according to claim 31, wherein said polymeric film comprises a polymer selected from the group consisting of: polystyrene, polyolefins, polyvinylchloride, polyamides, polyester, nylon, copolymers thereof, and mixtures thereof.

40. A method according to claim 39, wherein said polyolefin is selected from the group consisting of polyethylene and polypropylene.

41. A method according to claim 31, wherein said polymer film is capable of acting as a barrier against gas diffusion and/or UV radiation.

42. A method according to claim 41, wherein said gas is oxygen, nitrogen, air, CO₂ and/or water vapor.

43. An article wrapped with a heat shrinkable polymeric film in accordance with the method of claim 31.

44. An article according to claim 43, having a form of a cylinder with non-uniform diameter.

45. An article according to claim 44, wherein the film wrapped around it is printed to form a label.

46. A method according to claim 31, further comprising the following step after step (a):
(a1) attaching said heat shrinkable polymeric film to at least one polymeric film to obtain a heat shrinkable multilayer; whereby steps (b) and (c) subsequently include
(b) surrounding at least a portion of the outer surface of said article with a portion of said heat shrinkable multilayer; and
(c) heating said heat shrinkable multilayer so as to shrink it around said article.

47. A method according to claim 46, wherein said attaching mentioned in (a1) is carried out by lamination or by coextrusion.

48. A method according to claim 31, wherein said polymeric film is composed of a plurality of layers attached to each other to produce a multilayer.

49. A polymeric sheet that is unidirectionally shrinked in the machine direction to 50% or less of its original dimension, preferably to 40% or less of its original dimension.

50. A polymeric sheet made of polyolefin, unidirectionally shrinked in the machine direction to 70% or less of its original dimension, preferably to 60% or less of its original dimension.

51. An article wrapped with a polymeric sheet in a wrap-around method along a first and a second location, the circumference in said first location being 50% smaller or more than a circumference in the second location.

52. An article wrapped with a polymeric sheet in a wrap-around method along a first and a second location, the circumference in said first location being 30% smaller or more than a circumference in the second location, characterized in that said polymeric sheet is olefinic.

53. An article according to claim 52, wherein said polymeric sheet is made of polyethylene and/or polypropylene.
